(19) United States
(12) Patent Application Publication
(10) Pub. No.: US 2018/0109827 A1
(43) Pub. Date: Apr. 19, 2018

(54) USER AFFINITY FOR VIDEO CONTENT AND VIDEO CONTENT RECOMMENDATIONS

(71) Applicant: International Business Machines Corporation, Armonk, NY (US)

(72) Inventor: Matthew R. Fleck, Pleasant Hill, CA (US)

(21) Appl. No.: 15/292,944

(22) Filed: Oct. 13, 2016

(51) Int. Cl. H04N 21/25; H04N 21/466

(52) U.S. Cl. CPC H04N 21/251; H04N 21/4667; H04N 21/4668

(57) ABSTRACT

Providing video content recommendations can include, in response to a selection of a video item received from a device of a first user, determining, using a processor, a first set of attributes of the video item, providing, using the processor, the first set of attributes to the device, and, in response to receiving, from the device, a second set of attributes selected from the first set of attributes, searching, using the processor, a data structure to determine a candidate video item that matches the second set of attributes. A preview of the candidate video item can be provided to the device using the processor.

### BACKGROUND

This disclosure relates to determining user affinity for video content and recommending video content to users. Video content providers such as cable companies, Internet-based video subscription services, and so forth utilize content recommendation engines to find and recommend video content such as television shows, videos, movies, etc. for users. Providing insightful recommendations can be a significant help and time saver since individuals spend a considerable amount of time searching for programs to watch.

Typically, recommendation engines make a recommendation based upon the viewing history associated with a users' subscription. In many cases, there is more than one person living in a household and watching video content using a single subscription. In such cases, discerning which person watched a given program may be difficult if not impossible. Further, the knowledge that a particular program was viewed through a given subscription does not provide any indication as to whether the individual(s) that watched the program actually enjoyed the content. It may be the case, for example, that the individual did not like the program. For these and other reasons, recommendations generated using conventional recommendation engines often have little to no value.

### SUMMARY

One or more embodiments are directed to methods of determining user affinity for video content and/or providing recommendations for video content. In one aspect, a method can include, in response to a selection of a video item received from a device of a first user, determining, using a processor, a first set of attributes of the video item, providing, using the processor, the first set of attributes to the device, in response to receiving, from the device, a second set of attributes selected from the first set of attributes, searching, using the processor, a data structure to determine a candidate video item that matches the second set of attributes, and providing, using the processor, a preview of the candidate video item to the device.

One or more embodiments are directed to systems for determining user affinity for video content and/or providing recommendations for video content. In one aspect, a system includes a processor configured to initiate executable operations. The executable operations can include, in response to a selection of a video item received from a device of a first user, determining a first set of attributes of the video item, providing the first set of attributes to the device, in response to receiving, from the device, a second set of attributes selected from the first set of attributes, searching a data structure to determine a candidate video item that matches the second set of attributes, and providing a preview of the candidate video item to the device.

One or more embodiments are directed to a computer program product for determining user affinity for video content and/or providing recommendations for video content. In one aspect, the computer program product includes a computer readable storage medium having program instructions embodied therewith. The program instructions are executable by a processor to cause the processor to perform a method. The method can include, in response to a selection of a video item received from a device of a user, determining, using the processor, a first set of attributes of the video item, providing, using the processor, the first set of attributes to the device, in response to receiving, from the device, a second set of attributes selected from the first set of attributes, searching, using the processor, a data structure to determine a candidate video item that matches the second set of attributes, and providing, using the processor, a preview of the candidate video item to the device.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example of a network computing system.

FIG. 2 illustrates an example architecture for a data processing system.

FIG. 3 illustrates an example method of generating recommendations for video content.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to determining user affinity for video content and recommending video content to users. One or more embodiments described within this disclosure are directed to determining attributes of video content that a user likes. A system, for example, is capable of constructing a search or query using the attributes. The system is capable of searching a data structure including video content that is tagged or otherwise annotated with attributes. The search can generate one or more candidate video items with attributes that satisfy the search.

In one or more embodiments, the system may send a preview of one or more of the candidate video items to a device of the user. Based upon one or more actions performed on the preview using the device, the system is capable of updating one or more user preferences for video content. The actions performed by the device that may be detected by the system may include, but are not limited to, playing the preview, not playing the preview, stopping playback of the preview, and so forth. Based upon the actions performed by the device, the system may make various determinations as to whether the user liked the preview or portions of the preview.

These and other aspects of the inventive arrangements are described below in greater detail with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

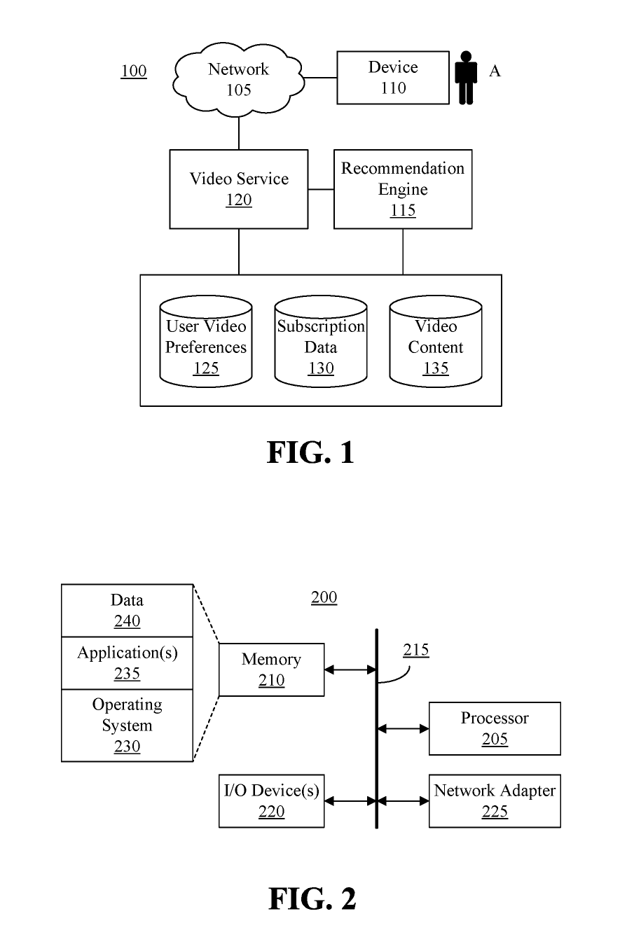

FIG. 1 illustrates an example of a network computing system 100 in accordance with one or more embodiments described herein. Network computing system 100 contains a network 105, a device 110, a content affinity engine (affinity engine) 115, and a video service 120. Network computing system 100 further may include storage devices 125, 130, and 135.

Network 105 is the medium used to provide communication links between various devices and data processing systems connected together within network computing system 100. Network 105 may include connections, such as wired communication links, wireless communication links, or fiber optic cables. Network 105 may be implemented as, or include, one or more or any combination of different communication technologies such as a Wide Area Network (WAN), a Local Area Network (LAN), a wireless network (e.g., a wireless WAN and/or a wireless LAN), a mobile or cellular network, a Virtual Private Network (VPN), the Internet, the Public Switched Telephone Network (PSTN), and so forth.

Device 110 may be any of a variety of computing devices that may be used by a user, e.g., user A, for interacting with affinity engine 115 and/or video service 120. Device 110 is capable of coupling to network 105 via wired and/or wireless communication links. In one or more embodiments, device 110 is a mobile phone that is adapted to execute program code such as one or more applications. In one or more other embodiments, device 110 is a set top box, e.g., a cable receiver, a satellite receiver, a media player, etc. Other examples of device 110 include, but are not limited to, a personal computer, a portable computing or communication device, a network computer, a tablet computer, a gaming console, etc.

Affinity engine 115 and video service 120 each may be implemented as a data processing system or as two or more networked data processing systems. Affinity engine 115 and video service 120 each may couple to network 105 via wired or wireless connections. As an illustrative example, affinity engine 115 and video service 120 each may be implemented as one or more servers. Though shown independently, in one or more other embodiments, affinity engine 115 and video service 120 are implemented in a same data processing system. For purposes of illustration, video service 120 may represent video delivery infrastructure of an Internet video content provider, a television network video provider, a cable based video provider, a satellite video provider, and so forth.

Storage devices 125, 130, and 135 each may be implemented as a data processing system such as a network attached storage device, a server, or etc. In one or more embodiments, one or more of storage devices 125, 130, and/or 135 may be integrated with or within video service 120 and/or affinity engine 115. For example, storage devices 125, 130, and/or 135 may host or execute a database thereby allowing each respective storage device to respond to read requests, write requests, search requests and/or queries, and so forth. One or more of storage devices 125, 130, and 135 may be combined into a single storage device.

In one or more embodiments, storage device 125 is capable of storing video preferences for users of video service 120. For example, the user video preferences for a particular user may include, but are not limited to, a history of viewed video items for the user, one or more attributes of video items that are liked and/or favored by the user, and so forth. Storage device 130 is capable of storing subscription data for users of video service 120. Subscription data for the users as stored in storage device 130 can be cross referenced with the user video preferences in storage device 125.

In one or more embodiments, storage device 135 stores video content. Storage device 135 is capable of storing a plurality of video items that are available for viewing by users of video service 120. As defined within this disclosure, the term “video item” refers to a unit of video content. Examples of video items include video files of various known formats in which content such as movies, television shows, Web-based video and/or shows, and the like may be encoded.

In one or more embodiments, the video items are associated with one or more tags, also referred to herein as “attributes,” within storage device 135. In one example, the tags, or attributes, are metadata for the video items. Examples of attributes with which video items may be tagged include, but are not limited to, a genre of the video item, actors and/or actresses appearing in the video item, the director of the video item, year of release of the video item, setting (e.g., locations) of the story of the video item, character(s) of the video item, producer of the video item, descriptive characteristics of the video item, and so forth.

In one embodiment, attributes may be applied to the video items as a whole and/or applied to particular portions of the video items. In one embodiment, there are two or more different varieties of attributes. One type of attribute may be general attributes that are associated with, or are applicable to, a video item as a whole. For example, attributes such as release date, directory, writer, genre, and so forth are likely applicable to the entire video item and, as such, are referred to as general attributes.

Another type of attribute is a time-specific attribute. A time-specific attribute is an attribute that is correlated with particular portions of the video items. For example, rather than tagging the entirety of a video item with a particular (general) attribute, one or more or all attributes may be time-specific attributes that are applied to only particular portions of the video item to which the time-specific attribute(s) are applicable. In one example, one or more time-specific attributes may be applied to the video items on a segment by segment basis, where a segment is a portion of a video item. The video items may be subdivided into segments based upon any of a variety of criteria.

In one example, a segment may be a frame or a plurality of frames of video. In another example, a segment may be defined according to a timeline for the video item. One or more of the time-specific attributes may be applied to a particular time and/or to a particular time span of the video item where the time-specific attributes are accurate descriptors of the content of the video item at that time, segment, or time span as the case may be. The attributes may not be applicable or accurate descriptors of segments of the video for which the time-specific attribute(s) are not applied.

In illustration, consider a video item where the time-specific attributes of “Texas” for the location and “Joe Smith” for the name of an actor appearing in the video item are assigned to a first segment but not to any other segment of the video item. In this example, the time-specific attributes of the first segment indicate that the first segment takes place in Texas and that the actor “Joe Smith” appears in the first segment. The lack of these time-specific attributes assigned to other segments of the same video item indicate that the location is not Texas for the other segments and that the actor “Joe Smith” does not appear in such other segments. In one or more embodiments, a given attribute such as “actor” may be specified as both general and time-specific. Referring to the previous example, the “actor” general attribute indicates that the actor “Joe Smith” appears in the video item, while the time-specific attribute indicates those particular segments of the video item in which the actor “Joe Smith” appears.

As another illustrative example, a video item may be considered part of the “action and adventure” genre, but have one or more segments that are considered comedy. By applying attributes to the video item on a per segment basis, a video item may be considered “action and adventure,” using a general attribute for genre, for example, while still having the relevant segments thereof tagged as “comedy” using time-specific attributes. While one or more time-specific attributes may be correlated with particular segments of video items, other general attributes may still be associated with video items as a whole.

In one or more other embodiments, the time-specific attributes may be more detailed than the general attributes. For example, a video item may be tagged with time-specific attributes such as “car chase,” “fight scene,” “argument,” or other descriptive time-specific attributes where each time-specific attribute indicates a detail of the content of the video item that occurs during the time or time-span of the video item to which the time-specific attribute corresponds. The time-specific attributes may provide increased granularity compared to the general attributes.

Video service 120 is capable of delivering video content from storage device 135 to client devices whether such devices are computers, hand held devices, mobile devices, set-top boxes, etc. Video content includes video items, previews, and the various attributes and data items described as being exchanged with device 110 herein. Video service 120 further may authenticate user(s) and/or devices for video content delivery using subscription data from storage device 130.

Affinity engine 115 is capable of communicating with users either directly (not shown) or through video service 120. Affinity engine 115, for example, may operate cooperatively with video service 120. Affinity engine 115 is capable of interacting with client devices to determine attributes of video items that the user(s) favor or like. Based upon the particular attributes affinity engine 115 determines a user likes, affinity engine 115 updates user video preferences within storage device 125. Affinity engine 115 and/or video service 120 is capable of recommending one or more video items to users for future viewing based upon the user video preferences stored in storage device 125.

In one or more embodiments, device 110 selects a particular video item. In one or more embodiments, the selected video item is one that the user has viewed. In illustration, user A may access device 110 and execute an application that is capable of communicating with video service 120 and/or affinity engine 115. The application may be adapted to allow the user to specify sentiment for particular video items and/or attributes of video items. The user may request a list of video items that the user has viewed or request a particular video item the user has viewed. Device 110 sends the request to affinity engine 115.

Affinity engine 115 is capable of retrieving attributes of the selected video item and providing the attributes to device 110. The attributes of the selected video item may be referred to as a “first set of attributes.” Device 110 is configured to present the first set of attributes for the selected video item through a user interface. In one embodiment, the first set of attributes includes only general attributes. In another embodiment, the first set of attributes includes general attributes and time-specific attributes. In still another embodiment, the first set of attributes includes only time-specific attributes.

The user interface generated by device 110, for example, is capable of receiving one or more user inputs selecting particular ones of the attributes of the selected video item thereby specifying a second set of attributes. The second set of attributes includes one or more of the attributes of the first set of attributes as selected by the user. While the second set of attributes may include all of the attributes of the first set, in general, the second set of attributes is typically a subset of the first set of attributes and includes at least one attribute selected from the first set of attributes. Device 110 is capable of sending the second set of attributes to affinity engine 115.

In response to receiving the second set of attributes, affinity engine 115 is capable of searching video content in storage device 135 for one or more other video items having attributes matching the second set of attributes. In one or more embodiments, affinity engine 115 is capable of constructing a search or query and executing the search against video content in storage device 135. Affinity engine 115 determines one or more candidate video items as results from the searching. Affinity engine 115 is capable of providing a preview of one or more or each of the candidate video items to device 110. Each preview of a candidate video item is a portion of the candidate video item.

Affinity engine 115 is capable of determining which, if any, of the previews of the candidate video items provided to device 110 are viewed or played through device 110. Further, affinity engine 115 is capable of determining whether the previews are played in their entirety, are stopped prior to finishing playback, and where the playback of the preview is stopped. Affinity engine 115 determines one or more preferences of the user based upon whether the previews are played, played fully, played partially, etc. Affinity engine 115 updates the user video preferences stored in storage device 125 based upon which of the foregoing actions are detected or reported back to affinity engine 115 from device 110.

In one embodiment, providing a video item and/or a preview to device 110 includes sending the actual content item. In another embodiment, providing a video item and/or a preview to device 110 include sending a link or other information that may be selected by a user through a user interface of device 110 thereby initiating the transfer, streaming, and/or download of the selected item.

FIG. 1 is provided for purposes of illustration and is not intended to limit the embodiments described herein. It should be appreciated that network computing system 100 may include fewer elements than shown or more elements than shown. For example, network computing system 100 may include fewer or more servers, clients, and other devices. In addition, one or more of the elements illustrated in network computing system 100 may be merged or combined.

FIG. 2 illustrates an example architecture 200 for a data processing system. Architecture 200 may be used to implement a device that is suitable for storing and/or executing program code. Architecture 200 is only one example of a suitable architecture for a communication device, computing device, etc. and is not intended to suggest any limitation as to the scope of use or functionality of the embodiments described herein. In one aspect, for example, architecture 200 may be used to implement video service 120 and/or affinity engine 115. In another aspect, architecture 200 may be used to implement a device such as device 110.

Architecture 200 includes at least one processor 205, e.g., a central processing unit (CPU), coupled to memory elements 210 through a system bus 215 or other suitable circuitry. Architecture 200 stores program code within memory elements 210. Processor 205 executes the program code accessed from memory elements 210 via system bus 215. In one aspect, architecture 200 may be used to implement a computer or other data processing system that is suitable for storing and/or executing program code. It should be appreciated, however, that architecture 200 may be used to implement any system including a processor and memory that is capable of performing the functions described within this disclosure.

Architecture 200 typically includes a variety of computer system readable media. Such media may be any available media that is accessible by processor 205 and may include volatile media and/or non-volatile media. Such media may be removable media and/or non-removable media. In one or more embodiments, memory 210 includes one or more physical memory devices such as a local memory and one or more bulk storage devices. Local memory may be implemented as a random access memory (RAM) or other non-persistent memory device(s) generally used during actual execution of the program code. A bulk storage device may be implemented as a hard disk drive (HDD), a solid state drive (SSD), or another persistent data storage device. Architecture 200 also may include one or more cache memories (not shown) that provide temporary storage of at least some program code in order to reduce the number of times program code must be retrieved from the bulk storage device during execution.

Input/output (I/O) devices 220 such as a keyboard, a display device, a pointing device, etc. optionally may be coupled to architecture 200. I/O devices 220 may be coupled to architecture 200 directly or through intervening I/O controllers. Architecture 200 may include one or more additional I/O device(s) beyond the examples provided. In some cases, one or more of I/O devices 220 may be combined as in the case where a touch sensitive display device (e.g., a touchscreen) is used. In that case, the display device may also implement the keyboard and/or the pointing device.

Architecture 200 may include, or be coupled to, a network adapter 225 either directly or through an intervening I/O controller. Network adapter 225 is a communication circuit capable of establishing wired and/or wireless communication links with other devices or systems. The communication links may be established over a network or as peer-to-peer communication links. Accordingly, network adapter 225 enables architecture 200 to become coupled to other systems, computer systems, remote printers, and/or remote storage devices through intervening private or public networks. Example network adapters 225 may include, but are not limited to, modems, cable modems, Ethernet cards, bus adapters, connectors, ports, wireless transceivers, wireless radios, and so forth. In the case of wireless communication, network adapter 225 may be configured for short and/or long range wireless communications.

Memory 210 stores an operating system 230 and one or more applications 235. Operating system 230 and application 235, being implemented in the form of executable program code, are executed by architecture 200. As such, operating system 230 and/or application 235 may be considered an integrated part of any system implemented using architecture 200. Application 230 and any data items used, generated, and/or operated upon by architecture 200 while executing application 235, e.g., data 240, are functional data structures that impart functionality when employed as part of architecture 200.

As defined within this disclosure, a “data structure” is a physical implementation of a data model's organization of data within a physical memory. As such, a data structure is formed of specific electrical or magnetic structural elements in a memory. A data structure imposes physical organization on the data stored in the memory as used by an application program executed using a processor. Examples of data structures include, but are not limited to, subscription data, video content and/or any attributes and/or tags for such video content, user video preferences, and/or other data items operated upon by a processor as described herein.

In the case where architecture 200 is used to implement a server type of data processing system, e.g., video service 120 and/or affinity engine 115, operating system 230 may be a server-side operating system; and, application 235 may be a server-side application that, when executed, causes the server to perform the various operations described herein. In the case where architecture 200 is used to implement a device such as device 110 of FIG. 1, operating system 230 may be a client-side operating system; and, application 235 may be a client-side application that, when executed, causes the client to perform the various operations described herein.

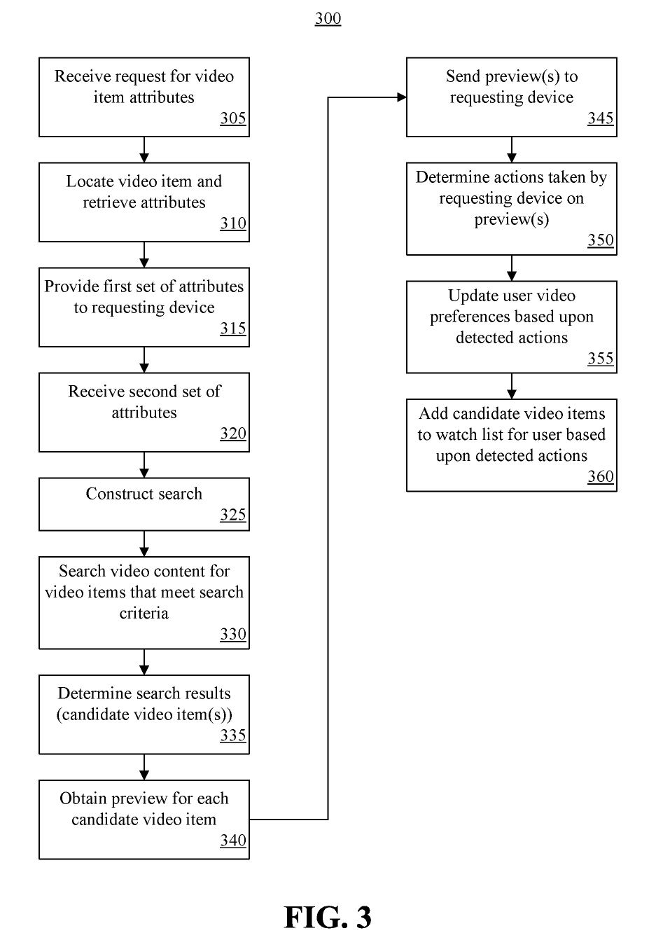

FIG. 3 illustrates an example method 300 of providing recommendations for video content. Method 300 may be performed by a system as described with reference to FIG. 1. In one or more embodiments, the operations described in connection with FIG. 3 are performed by affinity engine 115. In one or more other embodiments, the operations described in connection with FIG. 3 are performed by video service 120 operating in cooperation with affinity engine 115. For example, video service 120 may facilitate the operations performed by affinity engine 115 by handling communications with the requesting device. For discussion purposes, method 300 is described as being performed by the “system,” which may refer to affinity engine 115 or both video service 120 and affinity engine 115.

In block 305, the system receives a request for video item attributes from a requesting device. In one example, the requesting device may first request from the system a list of video items previously viewed for a particular subscription. A user, for example, may access an application on the requesting device and request a list of previously viewed video items for the purpose of obtaining recommended video content from the system. Responsive to a user input selecting a video item from the list of video items previously viewed, the requesting device may generate and send a request for the selected video item, or attributes of the selected video item, to the system. In another example, the requesting device may query the system for a particular video item, or for attributes of the selected video item. The requesting device may send the request responsive to a user input initiating the search for the purpose of obtaining video content recommendations from the system.

In block 310, the system locates the video item requested by the requesting device and retrieves the attributes for the requested video item. In one or more embodiments, the system determines that the user, by requesting attributes for the selected video item, likes the selected video item. Accordingly, the system may optionally update the video preferences for the user to indicate that not only has the user viewed the selected video item, but that the user likes the selected video item. In block 315, the system provides the attributes of the requested video item, referred to as the first set of attributes, to the requesting device. As noted, in one or more embodiments, the first set of attributes include only general attributes.

In one or more embodiments, responsive to receiving the first set of attributes, the requesting device is capable of displaying one or more or all of the attributes of the first set of attributes through a user interface generated by the requesting device. As presented through the user interface, the user of the requesting device may select any combination of one or more or all of the attributes of the first set of attributes. The attributes of the first set of attributes selected by the user form the second set of attributes. The second set of attributes includes at least one attribute selected from the first set of attributes, may include more than one such attribute, and may include all of the attributes of the first set of attributes. In general, the second set of attributes is typically a subset of the first set of attributes. The requesting device may send the second set of attributes to the system.

In block 320, the system receives the second set of attributes from the requesting device. In one or more embodiments, the system optionally updates the video preferences for the user responsive to receiving the second set of attributes. For example, the system, responsive to receiving the request for attributes for the selected video item may determine that the user does like the requested video item. Responsive to receiving the second set of attributes, the system may update the video preferences for the user in a more specific manner. Rather than only indicating that the user likes the selected video item, the system may update the video preferences for the user to indicate which of the first set of attributes the user selected. For example, the system may add the second set of attributes to the user's video preferences.

As an illustrative example, the system may determine that the user like video item A and the reasons why the user likes video item A are the second set of attributes. More particularly, the reasons why the user likes video item A are the second set of attributes and the values of such attributes. Thus, the user may not like each other video item of a same genre as video item A, but may like other video items of the same genre as video item A that also share the same attributes as the second set of attributes.

In block 325, the system constructs a search. For example, the system constructs a search and/or query specifying or including each attribute of the second set of attributes. In block 330, the system searches the video content for one or more video items that meet the search criteria. For example, the system is capable of searching the video content for video items having attributes that meet, e.g., are the same as, the attributes of the second set of attributes.

In one or more embodiments, the system is capable of searching for video items from the video content that have general attributes matching the criteria of the search, e.g., the second set of attributes. In one or more other embodiments, the system is capable of searching for video items from the video content that have time-specific attributes matching the criteria of the search. In one or more other embodiments, the system is capable of searching for video items that have general attributes and/or time-specific attributes (e.g., a combination thereof) that match the search criteria. In any case, for purposes of discussion, a video item from the video content that meets the search criteria is referred to as a “candidate video item.” Accordingly, in block 335, the system determines the search results that include one or more candidate video items.

In block 340, the system obtains a preview for each candidate video item determined in block 335. In one or more embodiments, previews for video items are pre-generated and stored within, or as part of, the video content. A preview, for example, may be a trailer or other promotional clip of the video item showing one or more scenes of a candidate video item.

In one or more other embodiments, the system is capable of automatically generating the preview. For example, the system is capable of selecting one or more portions of the candidate video item where the attributes correlated in time with the candidate video item, e.g., the time-specific attributes, match the second set of attributes. In one embodiment, where the search criteria include a plurality of attributes, the system may select one or more portions of the candidate video item where each selected portion is associated with at least one attribute of the second set of attributes. In another embodiment, where the search criteria include a plurality of attributes, the system may select only those portions of the candidate video item where each such portion is associated with each and every attribute of the second set of attributes. The system is capable of combining these selected portions into a preview. It should be appreciated that in generating the preview, the system may limit the length of each portion included, the number of portions included, and/or the total length of the preview. Further, the system may exclude certain portions associated with selected attributes that may be inappropriate for viewing by a general audience.

In one or more embodiments, for each video item for which a preview is sent to the requesting device, the system is capable of determining the attributes, e.g., the time-specific attributes, corresponding to each portion of the video item included in the preview. For example, the system is capable of maintaining a list of the time-specific attributes for each preview provided to the requesting device.

In block 345, the system sends one or more or all of the previews for the candidate video items to the requesting device. In block 350, the system determines actions taken by the requesting device on the preview(s). For example, the requesting device may notify the system as to which previews are selected for viewing (e.g., which previews are viewed), which previews are not selected for viewing (e.g., which previews are not viewed), whether a preview is viewed in its entirety, whether viewing of a preview is terminated before the end of the preview, the location where viewing of the preview is terminated, and/or whether a user input requesting addition of a candidate video item (as correlated with the particular preview being viewed) to the user's watch list is received.

In one or more embodiments, the requesting device may include “like” and/or “dislike” controls or other control elements as part of the user interface allowing the user to express positive, negative, and/or other sentiments for a preview during playback and/or at the conclusion of playback. It should be appreciated that in the context of a network computing environment, an action such as “liking” a video item and/or preview or otherwise expressing sentiment is a programmatic action that is detected by the system and persisted within a data structure.

In block 355, the system updates the video preferences for the user based upon the actions detected and discussed in block 350. For purposes of illustration, additional embodiments are described in the context of several different use cases below.

In one example, the user may choose not to view a preview for a highly scored recommendation. In that case, the system is capable of determining that the user has already viewed the recommended video item and/or the preview for the recommendation. The system, for example, may retain the information and utilize the information in the future as part of a retention campaign where the system reminds the user that the user may wish to watch the content again.

In another example, the user may view a preview in its entirety but take no action after viewing the preview. In that case, the system is capable of determining that the user did not like the preview enough to add the corresponding video item to the user's watch list. In one or more embodiments, the values of the attributes for this content, e.g., the time-specific attributes, may be compared against the values of attributes for content the user did select or “like.” The system, for example, is capable of identifying and/or generating a different preview for the recommended video item that better matches the video preferences for the user based upon which time-specific attributes the user “likes.”

In another example, the user may halt or discontinue viewing of a preview prior to completion of playback of the preview. The user, for example, may move to the next preview. In that case, the system is capable of determining that the user did not like one or more of the values of the time-specific attributes for the preview.

In block 360, the system (e.g., selectively) adds the candidate video items to the watch list of the user based upon the actions detected in block 350. For example, the system may detect a user request, through the requesting device, to add a candidate video item associated or linked with one of the previews to the user's watch list. In response to such a request, the system adds the candidate video item associated with the preview to the user's watch list. In that case, the system is capable of determining that the user liked the combination of values for the attributes for the preview.

In one or more other embodiments, the system may be used to provide recommendations for one or more other users based upon a determined similarity in viewing habits between the other user(s) and the user example described herein. For example, the system may determine that user B has a similar or same viewing history as user A, e.g., where both have viewed same or similar video items. In that case, the system may use the user video preferences of user A to provide video content recommendations to user B despite user B not utilizing the recommendation system and taking time to indicate which video items user B actually likes.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the term “another” means at least a second or more.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “coupled” means connected, whether directly without any intervening elements or indirectly with one or more intervening elements, unless otherwise indicated. Two elements may be coupled mechanically, electrically, or communicatively linked through a communication channel, pathway, network, or system.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments” or similar language mean that a particular feature, structure, or characteristic described in connection with the embodiment is included in at least one embodiment described within this disclosure. Thus, appearances of the phrases “in one embodiment,” “in an embodiment,” “in one or more embodiment,” and similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “plurality” means two or more than two.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
in response to a selection of a video item received from a device of a first user, determining, using a processor, a first set of attributes of the video item;
providing, using the processor, the first set of attributes to the device;
in response to receiving, from the device, a second set of attributes selected from the first set of attributes, searching, using the processor, a data structure to determine a candidate video item that matches the second set of attributes; and
providing, using the processor, a preview of the candidate video item to the device.

2. The method of claim 1, wherein the preview is associated with time-specific attributes, the method further comprising:
selectively updating video preferences for the first user using the time-specific attributes based upon detecting an action taken by the device upon the preview.

3. The method of claim 1, wherein the video item is marked as viewed by the first user.

4. The method of claim 1, wherein an attribute of the second set of attributes is correlated with a particular time of the candidate video item.

5. The method of claim 1, wherein an attribute of the second set of attributes is correlated with a specific portion of the candidate video item included in the preview.

6. The method of claim 1, further comprising:
updating a data structure of video preferences for the user based upon a detected action performed for the preview by the device.

7. The method of claim 6, wherein the detected action is whether the preview is played by the device.

8. The method of claim 6, wherein the detected action is an indication of positive sentiment responsive to playing the preview.

9. The method of claim 6, wherein the detected action is a termination of playing of the preview.

10. The method of claim 6, further comprising:
using the data structure of video preferences to generate a recommendation for a second user having a viewing history similar a viewing history of the first user.

11. A system, comprising:
a processor configured to initiate executable operations including:
in response to a selection of a video item received from a device of a first user, determining a first set of attributes of the video item;
providing the first set of attributes to the device;
in response to receiving, from the device, a second set of attributes selected from the first set of attributes, searching a data structure to determine a candidate video item that matches the second set of attributes; and
providing a preview of the candidate video item to the device.

12. The system of claim 11, wherein the preview is associated with time-specific attributes, the processor further configured to initiate executable operations including:
selectively updating video preferences for the first user using the time-specific attributes based upon detecting an action taken by the device upon the preview.

13. The system of claim 11, wherein the video item is marked as viewed by the first user.

14. The system of claim 11, wherein an attribute of the second set of attributes is correlated with a particular time of the candidate video item.

15. The system of claim 11, wherein an attribute of the second set of attributes is correlated with a specific portion of the candidate video item included in the preview.

16. The system of claim 11, wherein the processor is configured to initiate executable operations further including:
updating a data structure of video preferences for the user based upon a detected action performed for the preview by the device.

17. The system of claim 16, wherein the detected action is whether the preview is played by the device.

18. The system of claim 16, wherein the detected action is a termination of playing of the preview.

19. The system of claim 16, further comprising:
using the data structure of video preferences to generate a recommendation for a second user having a viewing history similar a viewing history of the first user.

20. A computer program product comprising a computer readable storage medium having program instructions embodied therewith, the program instructions executable by a processor to cause the processor to perform a method comprising:
in response to a selection of a video item received from a device of a user, determining, using the processor, a first set of attributes of the video item;
providing, using the processor, the first set of attributes to the device;
in response to receiving, from the device, a second set of attributes selected from the first set of attributes, searching, using the processor, a data structure to determine a candidate video item that matches the second set of attributes; and
providing, using the processor, a preview of the candidate video item to the device.
